(19) United States
(12) Patent Application Publication
(10) Pub. No.: US 2007/0133750 A1
(43) Pub. Date: Jun. 14, 2007

(54) Method for operation of a scattered-ray grid

(76) Inventors: Rainer Graumann, Hochstadt (DE); Dieter Ritter, Furth (DE)

Correspondence Address: SCHIFF HARDIN, LLP;PATENT DEPARTMENT, 6600 SEARS TOWER, CHICAGO, IL, 60606-6473, US

(21) Appl. No.: 11/599,037

(22) Filed: Nov. 14, 2006

(30) Foreign Application Priority Data
Nov. 14, 2005 (DE) 10 2005 054 240.9

(51) Int. Cl. G21K 1/00

(52) U.S. Cl. 378/155

(57) ABSTRACT

In a method for operation of a scattered-ray grid for an imaging system operating with x-rays, wherein an image of a part of a human or animal body to be examined is produced with the imaging system, is improved by evaluation of at least one property associated with the size of the body, and usage or non-usage of a scattered-ray grid in the production of the image are dependent on the evaluation of the property.

### BACKGROUND OF THE INVENTION

1. Field of the Invention

The present invention concerns a method for operation of a scattered-ray grid in an imaging system operating with x-rays.

2. Description of the Prior Art

Imaging systems operating with x-rays have been successfully used in medical technology for decades. X-rays that are emitted from an x-ray source penetrate a subject to be examined. X-rays are absorbed to different degrees depending on the thickness and composition of the subject. An image of the inside of the subject is produced by detecting the penetration of the x-rays. The detection of the x-rays can ensue in different ways, for example using conventional image amplifiers, suitable film materials, or with digital planar image detectors. It is a goal to achieve an optimally high image quality in order to acquire optimally precise information about the inside of the subject to be examined.

Likewise known for decades is the usage of scattered-ray grids in order to improve the image quality with regard to the contrast-noise ratio (CNR). Scattered radiation arises due to interaction of the x-rays (in particular due to Compton scattering) with the subject to be examined during the passage of the x-ray radiation through the subject to be examined, and contributes to an attenuation of the contrast in the image. Scattered-ray grids at least partially suppress the arising scattered radiation. 3D C-arm x-ray apparatuses that allow “cone beam” computed tomography to be implemented are relatively new and have only been developed in recent years. For this purpose, multiple x-ray images of a subject are produced from different directions. The three-dimensional image of the subject is calculated from these images (similar to the reconstruction of a three-dimensional image in computed tomography using a gantry). 3D C-arm x-ray apparatuses are designed similar to conventional C-arm x-ray apparatuses. The x-ray source is mounted at one end of the C-arm, the planar image detector is mounted at the opposite end of the C-arm. The subject to be imaged is located in the center point of the C-arm. In the production of the images the C-arm is moved around the subject located in the center point such that acquisitions from different directions can be produced over a large angle range. The reconstruction of the three-dimensional image composed of the two-dimensional exposures requires a high quality of the acquired images. By default, a scattered-ray grid has been conventionally used in such apparatuses. Nevertheless it cannot always be ensured that the reconstructed three-dimensional image has the desired quality.

In such apparatuses (as also for other imaging systems operating with x-rays) as before it is endeavored to improve the quality of the produced images since the quality and the accuracy of a diagnosis are thereby also increased.

### SUMMARY OF THE INVENTION

An object of the present invention is to provide a method for operation of an imaging system operating with x-rays with a scattered-ray grid, with which the quality of the generated image is improved.

This object is achieved in accordance with the present invention by a method for operation of a scattered-ray grid in an imaging system operating with x-rays, wherein an image of a part of a human or animal body to be examined is produced with the x-ray imaging system wherein at least one property associated with the size of the body is evaluated and usage or non-usage of a scattered-ray grid in the production of the image are dependent on the evaluation of the property.

A scattered-ray grid typically absorbs a portion of the arising scattered radiation, but it can itself also cause interference effects in the image. Of these two contradictory effects, the effect that improves the quality of the image (namely the advantageous absorption of the scattered radiation) normally predominates. The inventive method is based on the insight that, under certain conditions, the interference effects introduced by the scattered-ray grid can predominate. The greater the distance of the body to be examined, i.e. thus the greater the air gap between body and detector, the less the scattered radiation strikes the detector. Moreover, less scattered radiation arises given small bodies. In the inventive method an evaluation of a property associated with the size of the subject is undertaken and the scattered-ray grid is used dependent on the evaluation. The type of the evaluation is dependent on the respective imaging system, more specifically, dependent on the distance between the body to be examined and detector in the respective imaging system.

In an embodiment of the method the evaluation is implemented automatically using an evaluation unit. Such an evaluation unit is fashioned such that it takes into account the typically occurring geometric relationships in the production of an image and accordingly evaluates the properties of the body that correlate with its size. The evaluation unit determines whether it is advantageous or not to use a scattered-ray grid for a pending acquisition. For example, the evaluation unit can generate a signal that indicates whether the scattered-ray grid should be used. The quality of an acquisition thus can be improved and flawed exposures can be avoided.

In another embodiment of the method, the property associated with the size of the body is automatically determined from an electronic data record file that is associated with the body to be examined and is transferred into the evaluation unit. Such electronic data records often exist in a hospital regarding the patient to be examined and generally include data that describe the size of the patient to be examined (such as, for example, the patient's weight, length or the extent of specific body parts). It is therefore advantageous to use these already-present data since the time expenditure of a manual measurement of the patient to be examined and an input of the measurement data is thus not necessary.

In a preferred embodiment of the method, dependent on the previously-implemented evaluation, the scattered-ray grid is positioned in front of a detector using a mechanical positioner. This allows the scattered-ray grid to be positioned in front of the detector without an intervention by a user at the imaging system, which is in particularly advantageous given sterile conditions. When (as in another embodiment described above) the evaluation is conducted by the evaluation unit, this can generate a signal so that the positioning of the scattered-ray grid ensues entirely automatically for the production of an image.

The property associated with the size of the body can be a diameter or a circumference of the body. For example, the abdominal circumference can be measured when an image of the abdomen is to be generated with the imaging system, or the circumference of an extremity to be imaged. This embodiment has the advantage that the diameter or the circumference of a body part to be imaged correlates well with the path length of the x-ray radiation through the body part and thus also correlates well with the arising scattered radiation.

In a further embodiment of the method, the property associated with the size of the body is weight. The weight of a patient is usually known in advance, such that a new determination thereof is superfluous. In particular when electronic data records are used, the weight of a patient usually can be obtained there from.

The method also operates using the length of the body as the property associated with the size of the body in another embodiment.

Preferably, the property associated with the size of the body is determined using its length and its weight. Here the body mass index (BMI) (which is calculated from the length L and the weight G of the body according to the formula: BMI=G/L²) is preferably used. This value, which can be determined in a simple manner (usually without measurement since the weight and the length are known in advance), gives a simple quantitative estimate of how large the arising scattered radiation is and whether it is therefore advantageous to use a scattered-ray grid or not.

Depending on the imaging system or body part to be imaged, it can be advantageous to use other values similar to the BMI. Such values for example, can be the Broca index or the body surface of the patient, which can likewise be determined from the length and from the weight of the patient. The Broca index BI is calculated according to the formula BI=G/(L[cm]−100). The body surface can be calculated using one of the known formulas according to Mosteller, Haycock, Dubois, Gehan-George or Boyd as are known in the technical medical literature. These are used for assessment if and when they better correlate with the arising scattered radiation than the BMI.

In a particularly simple embodiment of the method, the evaluation of the property associated with the size of the body ensues by a comparison of the size with a limit value. The scattered-ray grid is used when the property (such as diameter, weight, length or values derived there from) is above a limit value.

The method is preferably used in a 3D C-arm apparatus. Such an x-ray apparatus has the advantage that the subject to be examined is always located at a defined distance from the detector, since the subject is located in the center point of the C-arm for the production of the image. Given a typical film-focus distance (FFA) of approximately 120 cm in a C-arm, the distance of the subject from the detector is always approximately 60 cm (FFA/2). The air gap that thereby arises thus is large enough so that, for a small subject to be imaged, the arising scattered radiation that strikes the detector is so low that the usage of a scattered-ray grid has a disadvantageous effect.

In a further embodiment of the method that contributes to an image improvement, particularly for imaging systems with a variable separation of the subject to be examined and the detector, in addition to the evaluation of the at least one property that is associated with the size of the body a further evaluation of the distance of the body to be examined relative to the scattered-ray grid is implemented. The usage of the scattered-ray grid in the production of the image ensues dependent on both evaluations. In this embodiment of the method a variable separation of the subject to be examined and the detector is also accommodated.

### DESCRIPTION OF THE DRAWINGS

FIG. 1 is a diagram that shows the dependency of the contrast-noise ratio on the phantom-detector separation in a 3D C-arm x-ray apparatus with and without scattered-ray grid.

FIG. 2 shows the same dependency as in FIG. 1, but with the phantom being provided with a fat ring.

FIG. 3 schematically illustrates, a 3D C-arm x-ray apparatus with which the inventive method is implemented.

### DESCRIPTION OF THE PREFERRED EMBODIMENTS

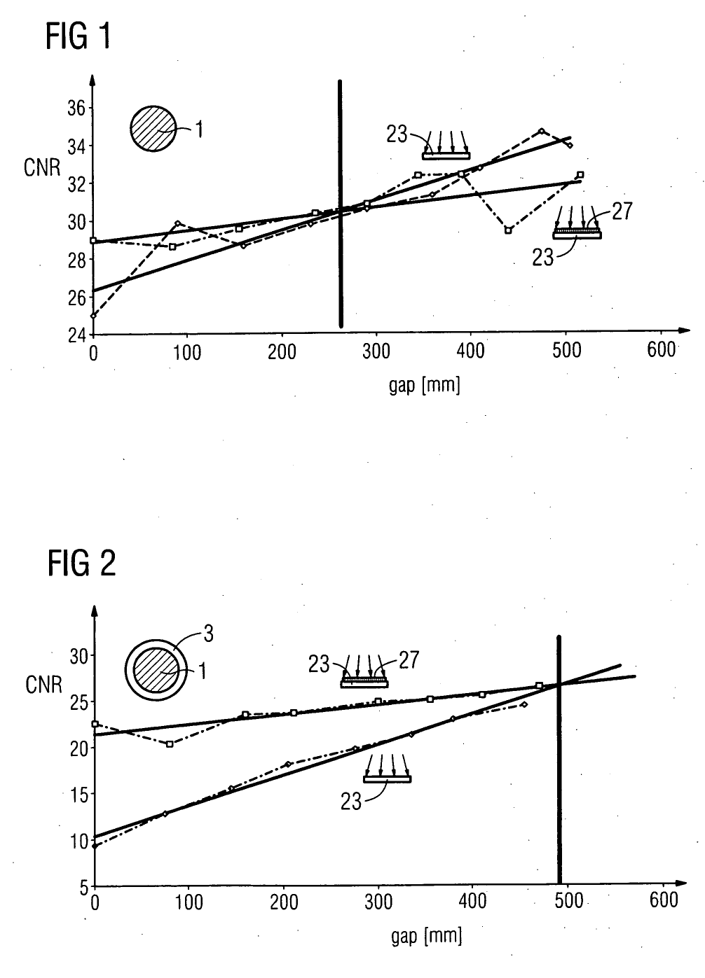

FIG. 1 shows the dependency of the contrast-noise ratio (CNR) in the imaging of a phantom 1, dependent on the size of the air gap between the phantom 1 and a detector 23. The phantom is dimensioned such that it corresponds to a patient of normal weight. The dependency is shown with (squares) usage of a scattered-ray grid 27 and without (diamonds) usage of a scattered-ray grid 27.

For a separation that is smaller than approximately 280 mm, the scattered-ray grid 27 generates an improvement of the contrast-noise ratio. When the separation is greater than approximately 280 mm, however, the image quality is better when no scattered-ray grid 27 is used. In this case the air gap is so large that only a small portion of the arising scattered radiation strikes the detector 23. When a scattered-ray grid 27 is used, the interference effects introduced by the scattered-ray grid 27 then predominate.

Like FIG. 1, FIG. 2 shows the dependency of the contrast-noise ratio (CNR) for the imaging of a phantom 1 dependent on the size of the air gap between the phantom 1 and the detector 23. In contrast to FIG. 1, a fat ring 3 is arranged around the phantom 1 so that the phantom 1 is distinctly larger than the phantom 1 used in FIG. 1 and corresponds to an adipose patient body. Here as well the dependency is shown with (squares) usage of a scattered-ray grid 27 and without (diamonds) usage of a scattered-ray grid 27.

Due to the fat ring 3 of the phantom 1, the phantom 1, is larger overall, such that more scattered radiation also arises. The usage of a scattered-ray grid 27 therefore has an advantageous effect for the image quality even for separations greater than 280 mm. Only when the separation becomes 490 mm is the air gap large enough so that the interference effects introduced by the scattered-ray grid 27 outweigh the improvement in the image quality.

When, in an imaging system operating with x-rays, a relatively larger air gap exists due to the geometry of the imaging system, such as, for example, in a 3D C-arm x-ray apparatus 11 in which the distance between the body 19 to be examined and detector 23 is half of the film-focus separation, may be or may not be advantageous to use the scattered-ray grid 27 dependent on the size of the subject.

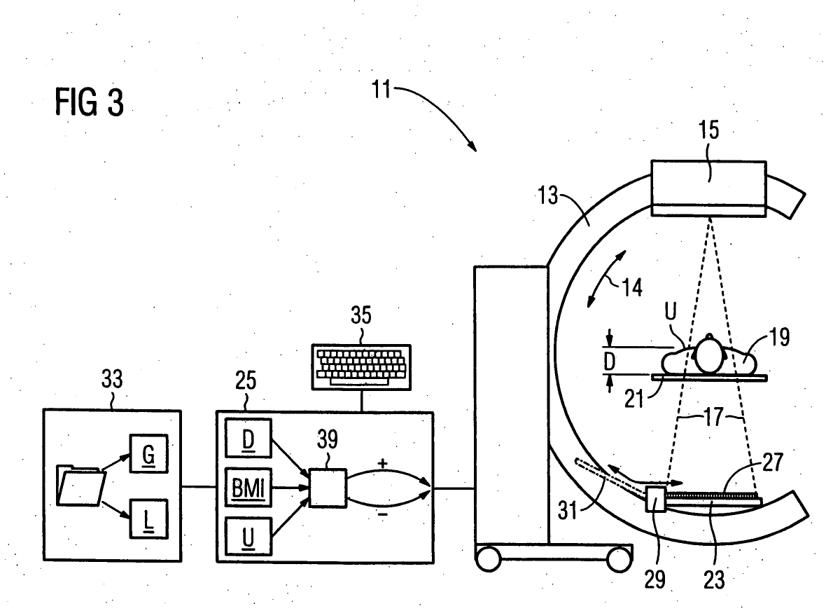

FIG. 3 shows a 3D C-arm x-ray apparatus 11 as is used in “cone beam” computed tomography.

In such a C-arm x-ray apparatus 11 an x-ray source 15 is mounted at one end of a C-arm 13. X-rays 17 are emitted from the x-ray source is and penetrate the body 19 of a patient to be examined, who is supported in the middle point of the C-arm 13 on a patient bed 21. The x-ray radiation 17 is measured by a detector 23 (for example a planar image detector for digital image acquisition) on the opposite end of the C-arm 13. The C-arm 13 can be rotated in the direction of the double arrow 14. It is thereby possible to produce two-dimensional exposures of the body 19 from a number of different directions, such that a computer 25 connected with the C-arm x-ray apparatus 11 can produce from the two-dimensional exposures a three-dimensional reconstruction of a body part of the patient to be examined.

In 3D C-arm x-ray apparatuses 11 the body 19 is located in the center of the C-arm 13, while the detector 23 is arranged at the edge of the C-arm 13. A separation, typically of approximately 60 cm, thereby results between the body 19 and the detector 23. The air gap between the body 19 and the detector 23 is consequently relatively large. As shown in FIG. 1 and FIG. 2, in such a case (dependent on the size of the body 19) it can be advantageous not to use a scattered-ray grid 27 in the image production. According to the invention the scattered-ray grid 27 is used only when the body 19 to be examined is adipose (more precisely, when the body part to be examined is sufficiently large so that, in spite of the large air gap, sufficient scattered radiation always still strikes the detector 23), such that the image quality is improved by the scattered-ray grid 19.

In the exemplary embodiment a positioner is arranged in the region of the detector 23, the positioner positions the 29 scattered-ray grid 27 in front of the detector 23 or at a position 31 outside of the ray path 17. A manual application of the scattered-ray grid 27 can be avoided in this manner, which is particularly useful given interventional procedures in which sterile operating conditions are necessary, to minimize the risk of making the sterile environment unsterile.

The computer 25 connected with the 3D C-arm x-ray apparatus 11 is fashioned to evaluate diverse patient data and to control the positioner 29 dependent on the evaluation, such that the scattered-ray grid 27 is moved into or out of the beam path.

For this purpose, the computer 25 can accept data that are stored in an electronic data record 33 and that are associated with the patient. For example, often the length L and the weight G of the patient are stored in an electronic data record 33, such that the thickness of the body 19 or the thickness of a body part can be roughly estimated there from. The body mass index (BMI) (which is calculated from the length L and the weight G of the body according to the formula: BMI=G/L²) can be used. In an embodiment, the computer 25 gives the positioner 29 a signal for insertion of the scattered-ray grid 27 when the BMI of the patient lies above a limit value 39.

As an alternative to the BMI, other measures can also be used that result from the size G and the length L of the patient and that can be used as a measure for the thickness of the body 19. Examples of this are, for instance, the Broca Index or the body surface that can likewise be determined from the length L and from the weight G of the patient.

In addition to the length L and the weight G of the patient, the evaluation unit can evaluate other properties that are associated with the size of the body 19. For example, when an image of the thorax is to be produced. The diameter D or the circumference U of the thorax can also be evaluated so that the scattered-ray grid 27 is used when the diameter D or the circumference U of the extremity lies above a limit value 39.

If the variables used in the evaluation implemented by the computer 26 are not stored in the patient record 33, they can be input into the computer 25 by a user (not shown) via, for example, a keyboard 35.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for operating a scattered ray grid in an x-ray imaging system, comprising the steps of:
electronically evaluating at least one property associated with a size of a body of a subject to be irradiated with x-rays;
selecting a scattered ray grid dependent on said electronic evaluation of said at least one property; and
irradiating said examination subject with x-rays passing through the selected scattered ray grid to produce an x-ray image of the examination subject.

2. A method as claimed in claim 1 comprising automatically electronically evaluating said at least one property using an evaluation unit.

3. A method as claimed in claim 2 comprising automatically electronically determining said at least one property from an electronic data record associated with the examination subject, by transferring said electronic data record into said evaluation unit.

4. A method as claimed in claim 1 comprising detecting said x-rays with a radiation detector, and positioning said scattered ray grid in front of said radiation detector dependent on said evaluation.

5. A method as claimed in claim 1 comprising using a diameter or a circumference of the size of the body of the examination subject as said at least one property.

6. A method as claimed in claim 1 comprising using a weight of the body of the examination subject as said at least one property.

7. A method as claimed in claim 1 comprising using a length of the body of the examination subject as said at least one property.

8. A method as claimed in claim 1 comprising determining said at least one property associated with the size of the body of the examination subject using a length of the body and a weight of the body.

9. A method as claimed in claim 8 comprising calculating a body mass index of the body of the examination subject as said at least one property.

10. A method as claimed in claim 1 comprising detecting said x-rays using a radiation detector, and placing said scattered ray grid in front of said radiation detector if said at least one property exceeds a limit value.

11. A method as claimed in claim 1 comprising irradiating said examination subject with a 3D C-arm x-ray apparatus.

12. A method as claimed in claim 1 comprising, in addition to evaluating said at least one property associated with the size of the body of the examination subject, evaluating a distance of the body of the examination subject with respect to the scattered ray grid, and using said scattered ray grid during irradiation of the examination subject to produce said x-ray image dependent both on the evaluation of said at least one property and the evaluation of the distance.
